(19) United States
(12) Patent Application Publication
(10) Pub. No.: US 2005/0010591 A1
(43) Pub. Date: Jan. 13, 2005

(54) Security issuer disclosure data interface

(76) Inventors: Roland C. Beaulieu, Littleton, MA (US); Andre G. Lavoie, Boston, MA (US)

Correspondence Address: ST. ONGE STEWARD JOHNSTON & REENS, LLC, 986 BEDFORD STREET, STAMFORD, CT, 06905-5619, US

(21) Appl. No.: 10/844,691

(22) Filed: May 13, 2004

Related U.S. Application Data
(60) Provisional application No. 60/471,386, filed on May 16, 2003.

(51) Int. Cl. G06F 7/00

(52) U.S. Cl. 707/102

(57) ABSTRACT

An apparatus, system, and method for efficiently accessing security issuer disclosure data in storage. The apparatus includes a server, a storage accessible by said server, said storage having stored thereon at least one security issuer disclosure data, said disclosure data partitioned into at least two portions that are categorized by subject matter type, a user interface in communication with said server, and a selectable connection displayed on said user interface for each of said at least two portions and each said selectable connection delivers one of said at least two portions of disclosure data when said selectable connection is activated.

### PRIOR APPLICATION

Applicant claims priority benefits under 35 U.S.C. §119(e) of U.S. Provisional Patent Application Ser. No. 60/471,386 of May 16, 2003.

### FIELD OF THE INVENTION

The present invention provides an apparatus, system, and method for searching and retrieving security issuer disclosure information from storage based on user input into a taxonomical interface.

### BACKGROUND OF THE INVENTION

The Securities and Exchange Commission adopted new rules and amendments on Oct. 23, 2000 entitled Regulation FD (Fair Disclosure). In response to Regulation FD, most security issuers have increased the frequency and quantity of company disclosure information that is released to the general public. As a result, the public has been inundated with a flood of available security issuer disclosure information.

The availability of such a large amount of security issuer disclosure information has created problems for investors attempting to obtain important and relevant data from the random and massive pool of available security issuer disclosure information. In response to this problem, a number of websites have been developed that attempt to provide access to the myriad of documents that comprise security issuer disclosure information.

For example, websites such as www.cbsmarketwatch.com, www.multex.com, www.quote.bloomberg.com, www.finance.yahoo.com, and the like all aggregate security issuer disclosure information by presenting numerous hyperlinks to various documents of security issuer disclosure information. However, the hyperlink form of access to security issuer disclosure information creates at least two significant problems that limit the effectiveness of searching and retrieving security issuer disclosure information from a database.

First, the hyperlink method forces a user to invest time and effort to cull through large amounts of data to obtain the desired information because a hyperlink does not enable the fine tuning of a search. For example, each data set represented by a hyperlink is predetermined and therefore the data set returned by the activation of the hyperlink will always be the same. Consequently, a user cannot access security issuer disclosure information according to their research needs but instead are limited to accessing the security issuer disclosure information according to the predetermined organizational structure of the hyperlinks.

And secondly, the hyperlink method does not enable the searching of combined data sets because the number of possible permutations of combined data sets will generally render this technique less efficient than searching the data sets individually. For instance, if a user wanted to research at substantially the same time the annual reports of three different companies, the state of the art does not provide such functionality because just the listing of the hyperlinks of the various permutations of company combinations would be very large and therefore searching through the hyperlinks representing the various permutations of company combinations would take as much time, if not more time, as individually searching each company.

Accordingly, the two above described problems in the prior art force a user into searching and retrieving security issuer disclosure information from a database according to a single company identifier, e.g. ticker symbol, and/or through whatever predetermined data sets are represented by given hyperlinks. As a result, the user will have to execute multiple searches if information about multiple companies is desired or if multiple pieces of information about a single company are needed because there is presently very minimal control available to a user to control what security issuer disclosure data is retrieved from a database.

Consequently, there is a need to enable users greater control over how the deluge of security issuer disclosure information can be searched and retrieved from a database.

### SUMMARY OF THE INVENTION

Accordingly, it is an object of the present invention to provide a novel apparatus, system, and method to substantially simultaneously search and retrieve disclosure information for multiple security issuers from storage.

Another object of the invention is to provide a novel apparatus, system, and method to enable a user to select a plurality of search parameters that are invoked at substantially the same time thereby granting the user control of how the search and retrieval of security issuer disclosure information will be performed.

A further object of the invention is to provide a novel apparatus, system, and method to present together the selected search parameters with the retrieved security issuer disclosure information for each search.

Still another object of the invention is to retrieve particular portions of security issuer disclosure information while not retrieving other portions of security issuer disclosure information for a given company as a result of chosen selectable connections and/or selectable characteristics.

Still yet another object of the invention is to provide a novel apparatus, system, and method to display a single day view of security issuer disclosure information that is visually categorized by filing group.

These and other objects of the present invention are achieved by provision of an apparatus for efficiently accessing security issuer disclosure information in storage comprising a server, a storage accessible by said server, said storage having stored thereon a set of security issuer disclosure information, a user interface in communication with said server, a plurality of primary selectable connections displayed on said user interface and in communication with said server, said primary selectable connection defining a primary search parameter utilized by said server, at least one selectable characteristic displayed on said user interface and in communication with said server, said selectable characteristic defining a secondary search parameter utilized by said server, said at least one selectable characteristic being selected from a plurality of selectable characteristics based upon which one said plualtriy of primary selectable connections is activated, and a selected on of said plurality of said primary selectable connections operating with a selectable one or ones of said at least one selectable characteristic to constrain delivery from said server to said user interface of said security issuer disclosure information according to a primary search parameter and at least one secondary search parameters defined by the selected one of said primary selectable connections and the selected one or ones of said at least one selectable characteristic.

Preferably, the apparatus wherein said primary selectable connection and said selectable characteristic are displayed together on said user interface with retrieved said security issuer disclosure information, said at least one security issuer disclosure information contains multiple portions, said selectable characteristic is directly linked to one security issuer disclosure information multiple portion, said at least one selectable characteristics enables the substantially simultaneous retrieval of security issuer disclosure information from a plurality of companies by defining said plurality of companies as a search parameter, and the apparatus further comprising a secondary selectable connection displayed on said user interface and in communication with said server, said secondary selectable connection for defining a secondary search parameter utilized by said server.

Other objects of the present invention are achieved by provision of an apparatus for efficiently accessing security issuer disclosure data in storage comprising a server, a storage accessible by said server, said storage having stored thereon at least one security issuer disclosure data, said disclosure data partitioned into at least two portions that are categorized by subject matter type, a user interface in communication with said server, and a selectable connection displayed on said user interface for each of said at least two portions and each said selectable connection delivers one of said at least two portions of disclosure data when said selectable connection is activated.

Still other objects of the present invention are achieved by provision of an apparatus for efficiently accessing security issuer disclosure information in storage comprising a server executing on a computer, a storage accessible by said server, said storage having stored thereon security issuer disclosure data, a user interface in communication with said server, a plurality of primary selectable connections displayed on said user interface and in communication with said server, said primary selectable connections defining a primary search parameter utilized by said server, at least one secondary selectable connection delivered when said primary selectable connection is activated, wherein said primary selectable connections and said at least one secondary selectable connections remain displayed on said user interface and said at least one secondary selectable connection operates with said primary selectable connection to constrain delivery from said server to said user interface of said security issuer disclosure information according to search parameters defined by said primary selectable connection and said at least one secondary selectable connection.

Preferably, the method further comprising a selectable characteristic displayed on said user interface and in communication with said server, said selectable characteristic for defining a secondary search parameter utilized by said server, said primary selectable connection causes to be delivered to said user interface from said server said selectable characteristic when said primary selectable connection is activated, a selectable characteristic displayed on said user interface and in communication with said server, said selectable characteristic for defining a secondary search parameter utilized by said server, said secondary selectable connection causes to be delivered to said user interface from said server said selectable characteristic when said primary selectable connection is activated, a selectable characteristic displayed on said user interface and in communication with said server, said selectable characteristic for defining a secondary search parameter utilized by said server, said secondary selectable connection causes to be delivered to said user interface from said server said selectable characteristic when said primary selectable connection is activated, and a selectable characteristic displayed on said user interface and in communication with said server, said selectable characteristic for defining a secondary search parameter utilized by said server, said primary selectable connection causes to be delivered to said user interface from said server said selectable characteristic when said primary selectable connection is activated.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a functional block diagram illustrating an embodiment of the hardware and/or software components for an apparatus, system, and method that facilitates the search and retrieval of security issuer disclosure information from storage in accordance with the principles of the present invention;

FIG. 2 is an exemplary flowchart illustrating the operation of an apparatus, system, and method that facilitates the search and retrieval of security issuer disclosure information from storage in accordance with the principles of the present invention of FIG. 1;

FIG. 3 is an example output of a search according to selected search parameters in accordance with the principles of the present invention of FIG. 1;

FIG. 4 is an example output of a search according to selected search parameters in accordance with the principles of the present invention of FIG. 1;

FIG. 5 is an example output of a search according to selected search parameters in accordance with the principles of the present invention of FIG. 1;

FIG. 6 is an example output of a search according to selected search parameters in accordance with the principles of the present invention of FIG. 1;

FIG. 7 is an example output of a search according to selected search parameters in accordance with the principles of the present invention of FIG. 1; and

FIG. 8 is an exemplary flowchart illustrating the flow of security issuer disclosure information within the system in accordance with the principles of the present invention of FIG. 1.

### DETAILED DESCRIPTION OF THE DRAWINGS

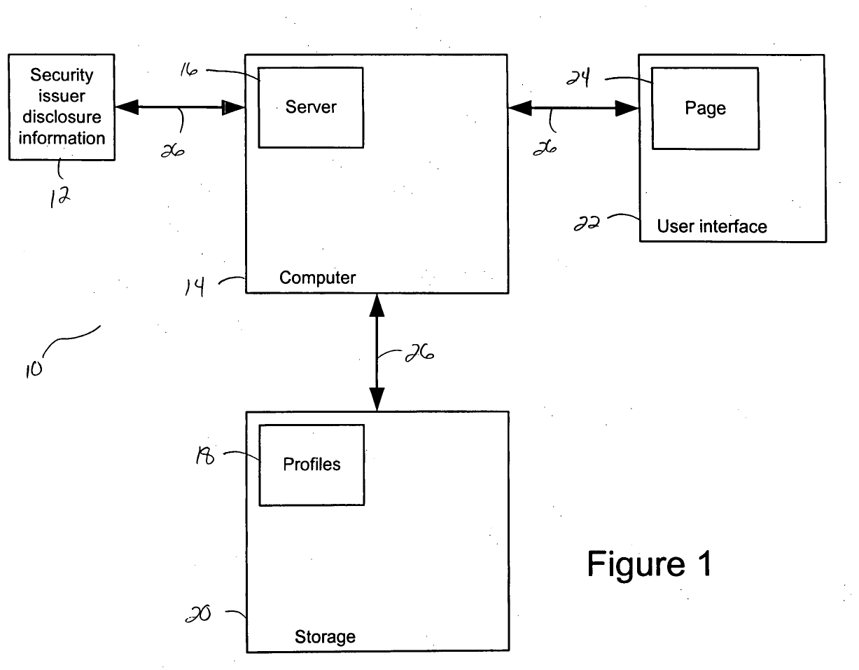

FIG. 1 is a functional block diagram illustrating an embodiment of the hardware and/or software components for an apparatus, system, and method that facilitates the search and retrieval of security issuer disclosure information from storage in accordance with the principles of the present invention and designated generally as system 10. System 10 is preferably comprised of at least one computer 14 and at least one user interface 22 each of which are coupled to communications network 26.

Communication network 26 includes networks, intra-networks, and/or inter-networks of all kinds, including the Internet, and is not limited to any particular network, intra-network, and/or inter-network. Communication network 26 can employ hardwired and/or wireless technologies.

Computer 14 is preferably a data processing device that is capable of sending and receiving data across communications network 26 and computer 14 has server 16 executing thereon. The processing, searching, and retrieving of security issuer disclosure information 12 is preferably performed by server 16 executing on computer 14 and server 16 can be implemented in hardware and/or software.

Computer 14 can be implemented in hardware and/or software and is a device such as a mainframe computer, mini-computer, personal computer, web enable television, laptop computer, personal digital assistant (PDA), electronic organizer, cell phone, and the like. Computer 14 communicates data to, and receives data from, user interface 22.

In one embodiment, user interface 22 is a thin client and in another embodiment, user interface 22 is a thick client. For example, in one embodiment, user interface 22 can be an access node such as a web browser executing on a remote computer and communicating with computer 14 over a global communications network such as the Internet or local network such as a local area network. In an alternative embodiment, user interface 22 can be an access node such as a network computer communicating with computer 14 over a communications network such as an intranet and/or the Internet. User interface 22 preferably includes a page 24, which displays portions of security issuer disclosure information 12 as well as search parameters such as selectable connections and selectable characteristics that control what portions of security issuer disclosure information 12 are displayed on user interface 22.

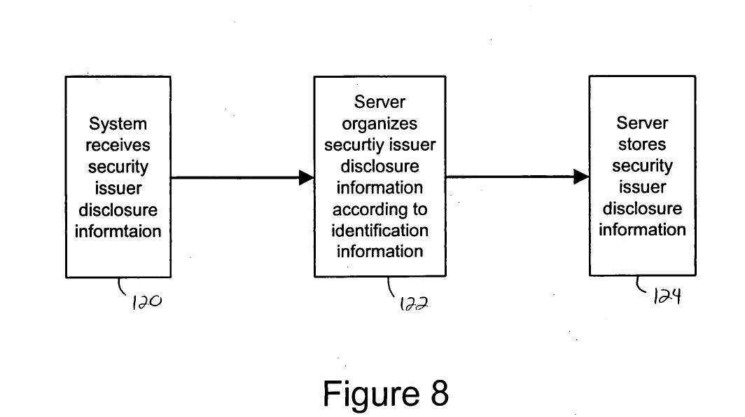

System 10 also includes at least one storage 20 that provides primary and/or secondary storage. Storage 20 is in communication with computer 14 and can store thereon security issuer disclosure information 12. For instance, referring to FIG. 8, server 16 can receive and send to storage 20 security issuer disclosure information 12 such as a quarterly filings, annual filings, earnings forecast, press releases, earnings calls, analyst's reports, corporate calls, conference presentations, proxy filings, mergers and acquisitions information, insider trading reports, sales reports, and the like of a plurality of companies, at block 120.

Server 16 organizes the security issuer disclosure information 12 according to identification information, at block 122. The organized security issuer disclosure information 12 can then be stored in storage 20, at block 124. In one embodiment, server 16 stores security issuer disclosure information 12 for a particular company into a profile 18. In another embodiment, server 16 stores security issuer disclosure information 12 for a particular company into a profile 18 for an industrial sector group for which a particular company may be a part of. In yet another embodiment, profile 18 is customizable by a user to include companies and/or groupings of companies that a user is interested in. In still yet another embodiment, no profile is utilized because security issuer disclosure information 12 is tagged with elements that define the subject matter and structure of security issuer disclosure information 12, using a common information format such as Standard Generalized Markup Language (SGML), Extensible Markup Language (XML), Extensible Hypertext Markup Language (XHTML), and the like. In yet another embodiment, both profile 18 and data tagged with elements is utilized.

In one embodiment, security issuer disclosure information 12 for a particular company is composed of multiple portions. For example, an earnings call/presentation is composed of a multimedia record of the event, a transcript of the multimedia record of the event, a summary of the transcript of the event, news stories about the event, and the like.

In one embodiment, all security issuer disclosure information 12 for a particular company is stored in a profile 18 that aggregates substantially all security issuer disclosure information 12 for that particular company. In another embodiment, a portion of security issuer disclosure information 12 for a particular company is stored with related subject matter portions of security issuer disclosure information 12 from other companies in a profile 18. In still yet another embodiment, security issuer disclosure information 12 is stored using a combination of the two preceding embodiments.

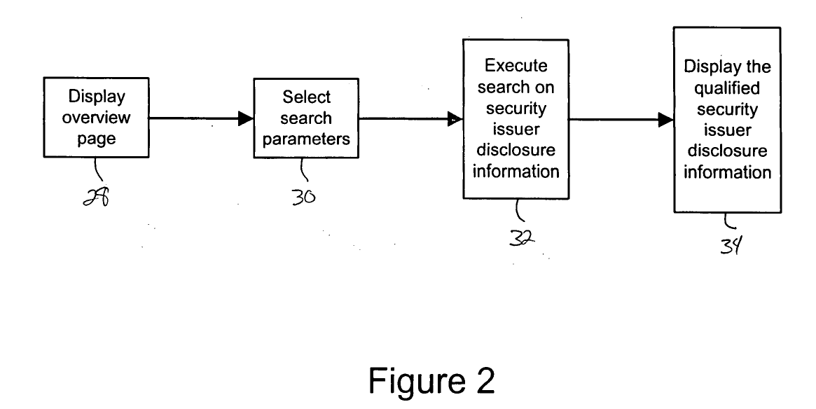

FIG. 2 is an exemplary flowchart illustrating the operation of an apparatus, system, and method that facilitates the search and retrieval of security issuer disclosure information from storage in accordance with the principles of the present invention. At block 28, an overview page, which is a version of page 24, is displayed on user interface 22. In one embodiment, the overview page can be a single file and in another embodiment, multiple files are presented on the overview page.

The overview page will have at least one selectable search parameter by which a user can control what security issuer disclosure information 12 is displayed on user interface 22 according to the selected search parameter, block 30. The selectable search parameter reduces the information searched and delivered to user interface 22 by defining search and retrieval parameters.

When the selectable parameters are chosen, then server 16 can execute a search on security issuer disclosure information 12, at block 32. Server 16 executes the search and accesses security issuer disclosure information 12 in storage 20. Server 16 sends qualified security disclosure information 12 retrieved from storage 20 to user interface 22 for display on a page 24, at block 34.

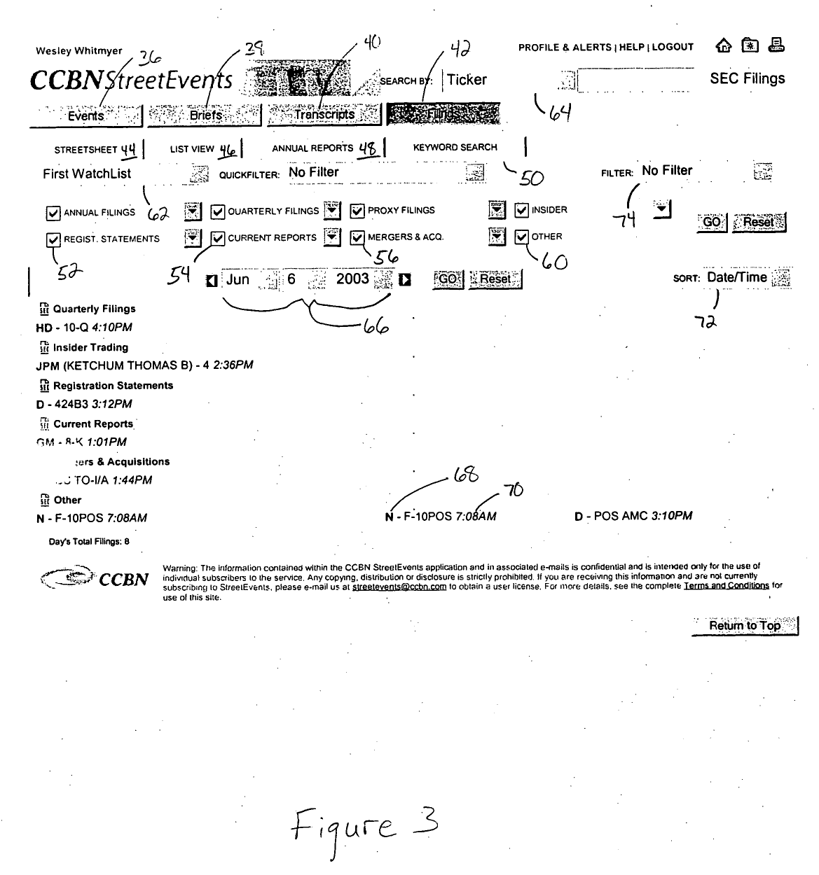

An example of qualified security issuer disclosure information 12 displayed on a page 24 on user interface 22 is illustrated in FIG. 3. FIG. 3 shows events 36, briefs 38, transcripts 40, and filings 42 comprise a primary level of selectable connections and the activation of each one delivers a predetermined secondary level of selectable connections for each heading. For instance, streetsheet 44, list view 46, annual reports 48, and keyword search 50 are a secondary level of selectable connections and are displayed when filings 42 is activated. This secondary level of selectable connections further enables a user to limit the data sets returned during the execution of a particular search. This secondary level of selectable connections is displayed according to which primary level of selectable connections is activated.

If a selectable connection in the secondary level is activated, a selection of selectable characteristics such as registration statements 52, current reports 54, mergers and acquisitions 56, other 60, and the like are displayed and/or enabled that will further enable a user to customize the data sets of security issuer disclosure information 12 that will be searched and retrieved. Profile list 62 will also limit the data sets of security issuer disclosure information 12 searched by enabling a user to select predetermined groupings of companies that are stored in profiles 18 such as first watchlist, second watchlist, all companies list, particular event list, all events list, and the like.

A watchlist is a custom grouping of companies, funds, exchanges, and such created by a user and saved to a profile 18 for convenient recall. For instance, a watchlist can be a listing of companies that a user has an ownership share in and/or a listing of companies that a user follows. Profile list 62 limits the search to the particular companies that are members of a selected watchlist. In the alternative, a search can be executed using ID tab 64 to select a search based on different identifications such as ticker symbol, company name, fund name, Central Index Key (CIK), Committee on Uniform Securities Identification Procedure number (CUSIP), International Securities Identification Number (ISIN), Stock Exchange Daily Official List (SEDOL), and the like.

Date line 66 enables a user to limit the data set returned to include data from a given period of time such a particular day, week, month, year, and the like. Filter 74 enables additional search and retrieval parameters including, but not limited to, no amendments, amendments only, no exhibits, and exhibits only. Sort 72 enables the data sets retrieved by a search to sorted according to a particular parameter such as data/time, ticker symbol, and the like.

Consequently, if all the selections discussed for FIG. 3 are made as shown and a search is executed, a data set will be displayed with the selectable connections and selectable characteristics that directed the search and retrieval of data. For instance, ticker symbol 68 was a member of the first watchlist and possessed other 60 data that was released on Jun. 6, 2003 at 7:08 AM. Additionally, ticker 68, like all the tickers in the figure, is a hyperlink that delivers the relevant document to a page 24. Additionally, in one embodiment, the relevant document retrieved by such a search will contain hyperlinks within the relevant document to facilitate ease of navigation throughout the relevant document.

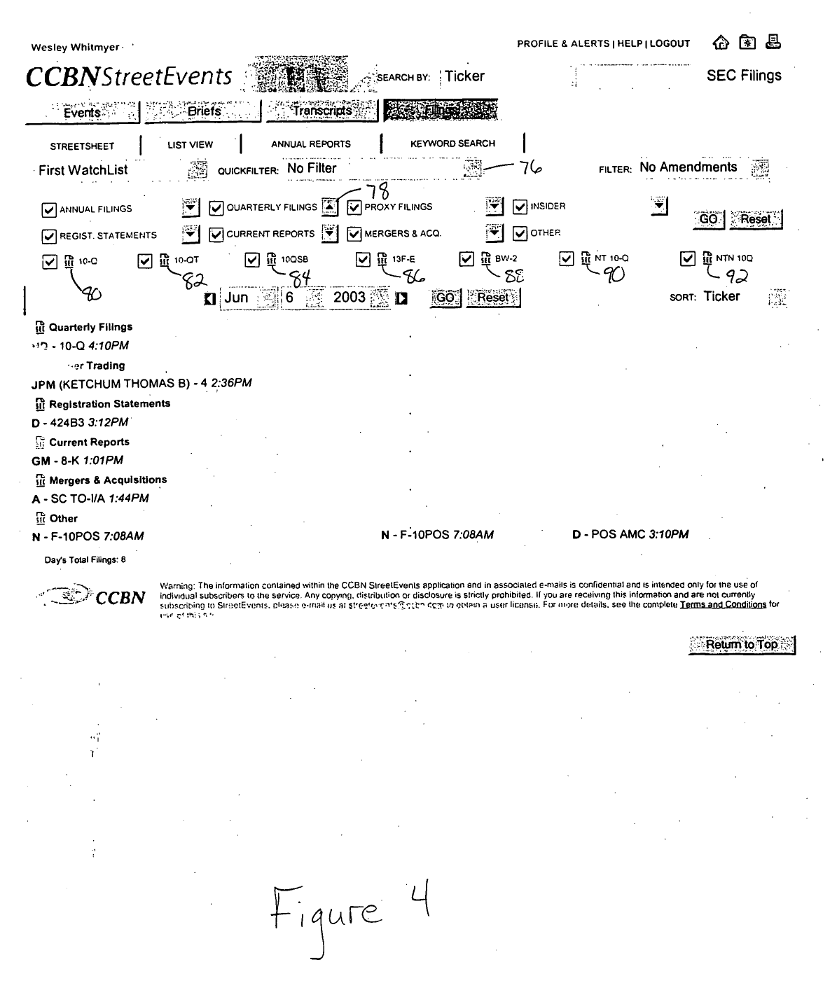

The search of FIG. 3 can be further be modified by additional parameters such as quickfilter 76 and secondary switch 78 of FIG. 4. Quickfilter 76 is a set of predetermined groupings of search parameters that can be selected according to a single selection. For example, a single selection can return a selection of search parameters such as the grouping 10-K, 10-Q, 8-K, 6-K, and DEF-14 or the grouping 10-K, 10-Q, 8-K, and 144. Secondary switch 78 is denoted as on by the upward tick on the selectable characteristic and presents another grouping of selectable characteristics such as 10-Q 80, 10-QT 82, 10SB 84, 13F-E 86, BW-288, NT 10-Q 90, NTN 10Q 92, and the like. Secondary switch 78 are selected for inclusion or exclusion from the search parameters by clicking on the adjacent box and either causing a check to be inserted thereby designating inclusion or removing a check thereby designating exclusion.

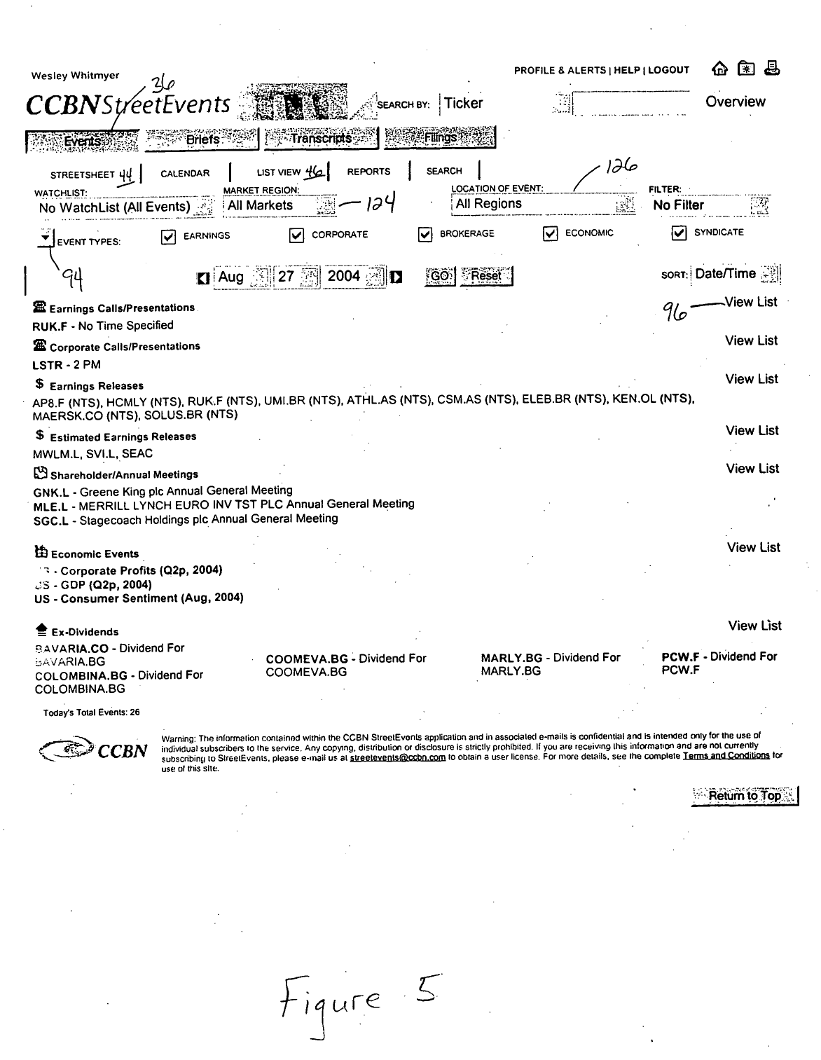

FIG. 5 is an example of a page 24 generated when primary selectable connection events 36 are selected as well as secondary selectable connection streetsheet 44. Market Region 124 enables a user to select a search parameter according to market region such as 1) North America, 2) Europe, Middle East, and Africa, 3) Asia-Pacific, 4) Latin America, and the like. Location of event 126 enables a user to select a search parameter according to a geographical area where the event occurred such as 1) US-North, 2) US-West, 3) Europe-East, 4) Europe-West, 5) Oceania AU/NZ, and the like.

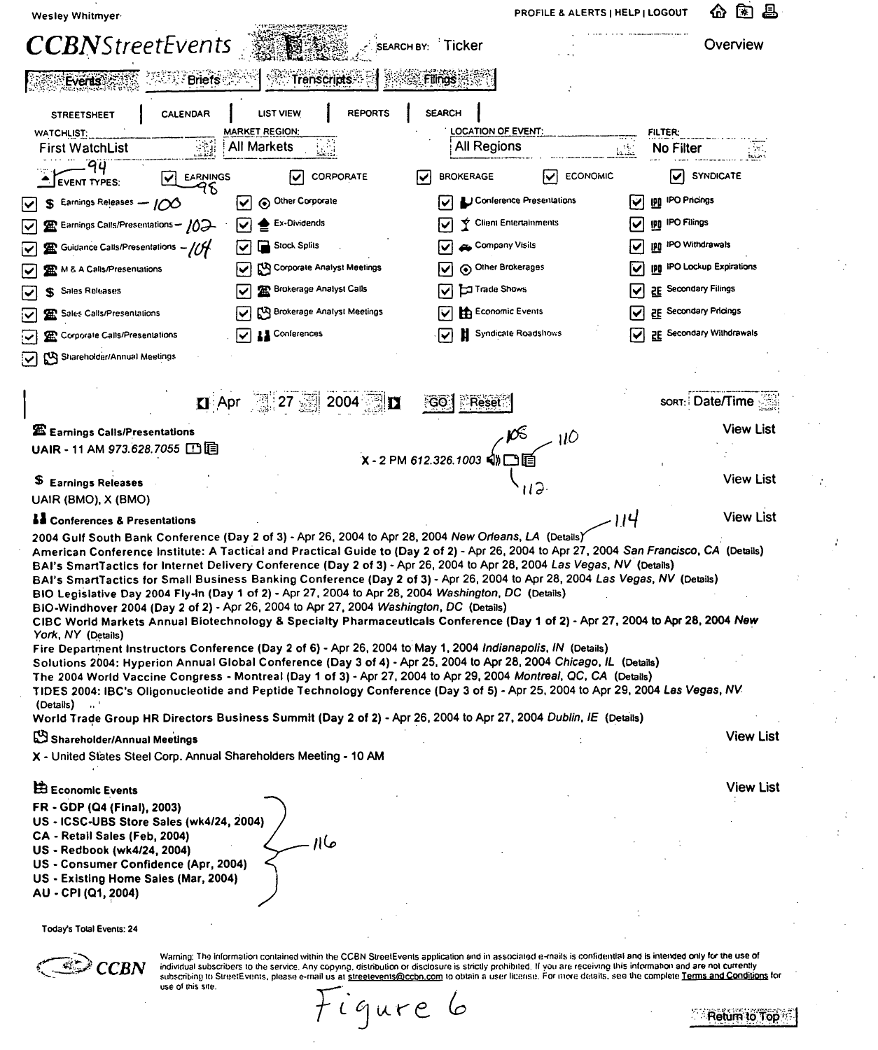

View list 96 changes the secondary selectable connection from its present selection to list view 46. List view 46 presents the security issuer disclosure information 12 in a list view manner and also includes a function that enables a user to make custom changes to their profiles 18. For instance, a company listed can be added to a watchlist or to a calendar for continued monitoring. In FIG. 5, event types switch 94 is not selected, however, event types switch 94 is selected in the example of FIG. 6 and this selection causes various selectable characteristics to be displayed.

For example, earnings 98 is selected and therefore selectable characteristics earnings releases 100, earnings calls/presentations 102, and guidance calls/presentations 104 are selected. As such, a user can then individually select or unselect the individual selectable characteristics. However, if earnings 98 is unselected, then selectable characteristics earnings releases 100, earnings calls/presentations 102, and guidance calls/presentations 104 would be unselected as a group.

Further, activation of Multimedia 108 delivers to a page 24 a multimedia presentation to user interface 22 of the earnings calls/presentations for the attendant ticker symbol. Selection of transcript 110 delivers to page 24 a written record of what was spoken at the earnings calls/presentations for the attendant ticker symbol and activation of summary 112 delivers to a page 24 a summary of the transcript. Selection of Details 114 hyperlink delivers to a page 24 event information concerning the conference and/or presentation. Economic events 116 are hyperlinks that deliver to page 24 the subject matter relevant to the hyperlink title.

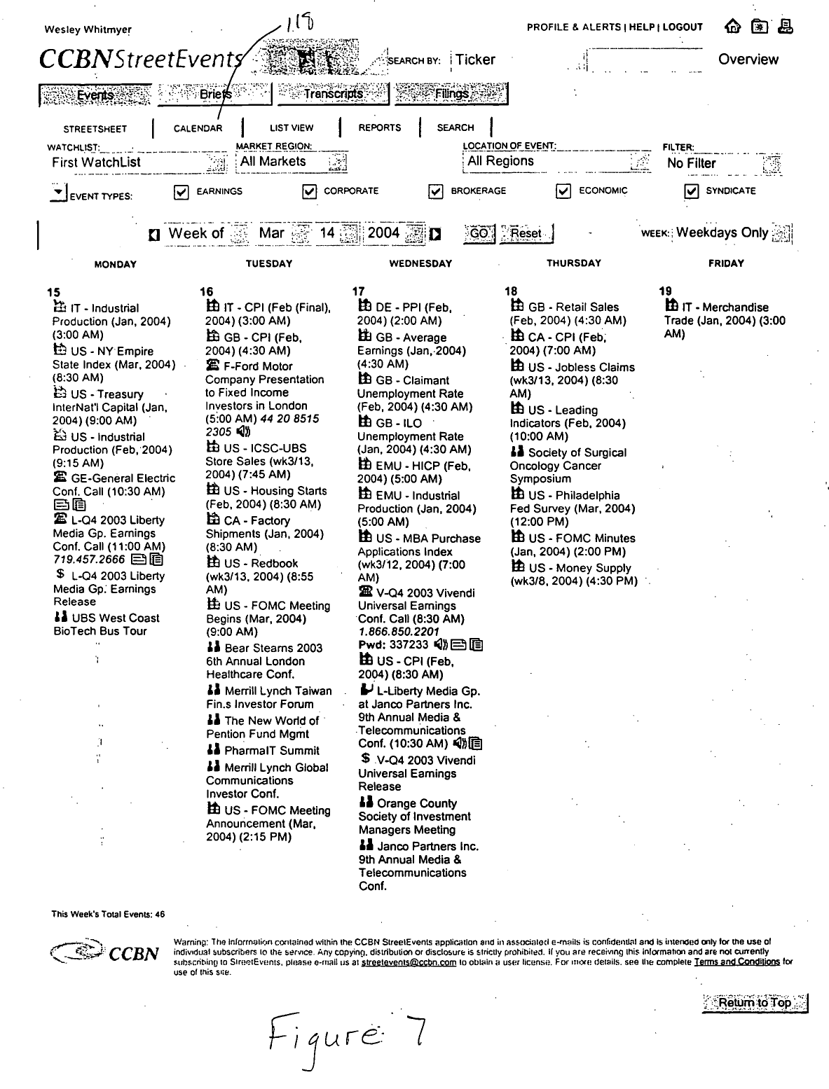

FIG. 7 is an example of a page 24 generated when primary selectable connection events 36 is selected as well as secondary selectable connection calendar 118. The calendar lists events as hyperlinks on the day the event is scheduled to occur.

In the embodiments of FIGS. 3, 4, 5, 6, and 7, it is illustrated that at least one of the primary selectable connections, at least one of the secondary selectable connections, and at least one of the selectable characteristics used to define the search parameters are presented with the security issuer disclosure information 12 retrieved by a search. In a preferred embodiment, all search parameters are available, whether displayed or not, with the retrieved security issuer disclosure information 12 and the non-displayed search parameters accessible by activating a switch such as secondary switch 78, event types switch 94, and the like. As such, a user can review the retrieved security issuer disclosure information 12 in view of the selected search parameters and can adjust the search parameters thereby enabling a user to shape the search as is deemed necessary by the user.

Although the invention has been described with reference to a particular arrangement of parts, features and the like, these are not intended to exhaust all possible arrangements or features, and indeed many other modifications and variations will be ascertainable to those of skill in the art.

1. An apparatus for efficiently accessing security issuer disclosure information in storage, the apparatus comprising:
a server;
a storage accessible by said server, said storage having stored thereon a set of security issuer disclosure information;
a user interface in communication with said server;
a plurality of primary selectable connections displayed on said user interface and in communication with said server, said primary selectable connection defining a primary search parameter utilized by said server;
at least one selectable characteristic displayed on said user interface and in communication with said server, said selectable characteristic defining a secondary search parameter utilized by said server, said at least one selectable characteristic being selected from a plurality of selectable characteristics based upon which one said plurality of primary selectable connections is activated; and
a selected on of said plurality of said primary selectable connections operating with a selectable one or ones of said at least one selectable characteristic to constrain delivery from said server to said user interface of said security issuer disclosure information according to a primary search parameter and at least one secondary search parameters defined by the selected one of said primary selectable connections and the selected one or ones of said at least one selectable characteristic.

2. The apparatus of claim 1 wherein said primary selectable connection and said selectable characteristic are displayed together on said user interface with retrieved said security issuer disclosure information.

3. The apparatus of claim 1 wherein said at least one security issuer disclosure information contains multiple portions.

4. The apparatus of claim 3 wherein said selectable characteristic is directly linked to one security issuer disclosure information multiple portion.

5. The apparatus of claim 1 wherein said at least one selectable characteristics enables the substantially simultaneous retrieval of security issuer disclosure information from a plurality of companies by defining said plurality of companies as a search parameter.

6. The apparatus of claim 1 further comprising a secondary selectable connection displayed on said user interface and in communication with said server, said secondary selectable connection for defining a secondary search parameter utilized by said server.

7. An apparatus for efficiently accessing security issuer disclosure information in storage, the apparatus comprising:
a server executing on a computer;
a storage accessible by said server, said storage having stored thereon security issuer disclosure data;
a user interface in communication with said server;
a plurality of primary selectable connections displayed on said user interface and in communication with said server, said primary selectable connections defining a primary search parameter utilized by said server;
at least one secondary selectable connection delivered when said primary selectable connection is activated;
wherein said primary selectable connections and said at least one secondary selectable connections remain displayed on said user interface and said at least one secondary selectable connection operates with said primary selectable connection to constrain delivery from said server to said user interface of said security issuer disclosure information according to search parameters defined by said primary selectable connection and said at least one secondary selectable connection.

8. The apparatus of claim 7 further comprising a selectable characteristic displayed on said user interface and in communication with said server, said selectable characteristic for defining a secondary search parameter utilized by said server, said primary selectable connection causes to be delivered to said user interface from said server said selectable characteristic when said primary selectable connection is activated.

9. The apparatus of claim 8 further comprising a selectable characteristic displayed on said user interface and in communication with said server, said selectable characteristic for defining a secondary search parameter utilized by said server, said secondary selectable connection causes to be delivered to said user interface from said server said selectable characteristic when said primary selectable connection is activated.

10. The apparatus of claim 7 further comprising a selectable characteristic displayed on said user interface and in communication with said server, said selectable characteristic for defining a secondary search parameter utilized by said server, said secondary selectable connection causes to be delivered to said user interface from said server said selectable characteristic when said primary selectable connection is activated.

11. The apparatus of claim 10 further comprising a selectable characteristic displayed on said user interface and in communication with said server, said selectable characteristic for defining a secondary search parameter utilized by said server, said primary selectable connection causes to be delivered to said user interface from said server said selectable characteristic when said primary selectable connection is activated.

12. An apparatus for efficiently accessing security issuer disclosure data in storage, the apparatus comprising:
a server;
a storage accessible by said server, said storage having stored thereon at least one security issuer disclosure data;
said disclosure data partitioned into at least two portions that are categorized by subject matter type;
a user interface in communication with said server; and
a selectable connection displayed on said user interface for each of said at least two portions and each said selectable connection delivers one of said at least two portions of disclosure data when said selectable connection is activated.
